(19) United States
(12) Patent Application Publication
(10) Pub. No.: US 2025/0386073 A1
(43) Pub. Date: Dec. 18, 2025

(54) METHODS AND SYSTEMS FOR MEDIA CONTENT STORAGE OPTIMIZATION

(71) Applicant: DISH Network Technologies India Private Limited, Bangalore (IN)

(72) Inventors: Sandeep Kumar Bhatta, Bangalore (IN); Himanshu Jain, Bangalore (IN)

(21) Appl. No.: 18/742,914

(22) Filed: Jun. 13, 2024

(51) Int. Cl. H04N 21/4335; H04N 21/214; H04N 21/231; H04N 21/466

(52) U.S. Cl. CPC H04N 21/4335; H04N 21/466; H04N 21/2143; H04N 21/23113

(57) ABSTRACT

The present disclosure is directed to systems and methods for optimizing storage of recorded media content. A storage optimization system can optimize the storage of recorded content by determining when to remove the recorded content from a storage device. The storage optimization system can analyze the consumption history of a user to determine parameters, such as the type of content the user records or how long the recorded content remains on the storage device before the user consumes or deletes the recorded content. The storage optimization system can utilize one or more machine learning or artificial intelligence algorithms to recommend when the user should delete recorded content from the storage device to optimize storage resources.

### BACKGROUND

A user can record media content on a storage device, such as a digital video recorder (DVR). In some cases, the stored media content is required to be stored locally on the storage device or at an on-premises server due to legal restrictions associated with the media content. Over time the storage capacity of a storage device can become overloaded as the user records additional media content. Limited storage can cause a degraded user experience and restrict the user’s ability to record content.

### BRIEF DESCRIPTION OF THE DRAWINGS

FIG. 1 illustrates an example of a distributed system for optimizing storage of recorded media content, in accordance with one or more embodiments of the present technology.

FIG. 2 illustrates an example input processing system for implementing systems and methods for optimizing storage of recorded media content, in accordance with one or more embodiments of the present technology.

FIG. 3 is a flow diagram illustrating a process used in some implementations for training a machine learning model to determine storage cleanup recommendations, in accordance with one or more embodiments of the present technology.

FIG. 4 is a flow diagram illustrating a process used in some implementations for removing stored media content from a storage device, in accordance with one or more embodiments of the present technology.

FIG. 5 is a flow diagram illustrating a process used in some implementations for determining the type of storage for a user, in accordance with one or more embodiments of the present technology.

FIG. 6 is a diagram illustrating an example system for optimizing storage of recorded media content, in accordance with one or more embodiments of the present technology.

FIG. 7 illustrates an example environment of operation of the disclosed technology.

FIG. 8 illustrates one example of a suitable operating environment in which one or more of the present embodiments may be implemented.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to systems and methods for optimizing storage of recorded media content. A user can record media content to a storage device, such as a digital video recorder (DVR), and consume (e.g., view, listen, interact with, etc.) the recorded content at a future time. The storage device can store the recorded content locally, such as on a hard drive, or at a server. Due to capacity limitations of storage devices, users generally need to delete previously recorded content to free/create space to record future content. A storage optimization system can optimize the storage of recorded content by determining when to remove the recorded content from the storage device. In some embodiments, the storage optimization system is for a multi-dwelling unit (MDU) and users at the MDU can share storage resources. Examples of an MDU can include an apartment building, apartment complex, hotel, retirement facilities, hospital, dormitory, or similar buildings or facilities.

The storage optimization system can analyze the consumption history of a user to determine parameters, such as the type of content the user records or how long the recorded content remains on the storage device before the user consumes or deletes the recorded content. The storage optimization system can utilize one or more machine learning or artificial intelligence algorithms to recommend when the user should delete recorded content from the storage device to optimize storage resources. For example, the storage optimization system analyzes a user’s behavior and determines that media content that has been recorded for more than a month is unlikely to be consumed by the user. Based on this determination, the storage optimization system provides the user with the recommendation to delete media content that has been recorded for more than a month. Thus, the storage optimization system assists the user clean up their storage device by removing recorded content that the user is unlikely to consume. The storage optimization system can be executed by a user device (e.g., a STB or DVR), a server, or a combination thereof.

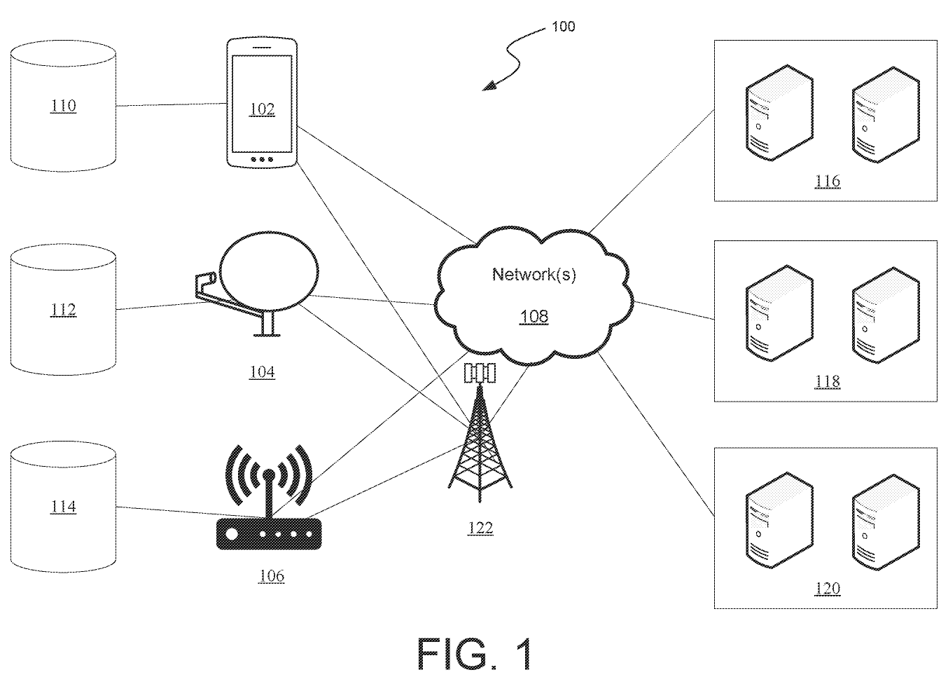

FIG. 1 illustrates an example of a distributed system for optimizing storage of recorded media content, in accordance with one or more embodiments of the present technology. Example system 100 presented is a combination of interdependent components that interact to form an integrated whole for optimizing storage of recorded media content. Components of the systems may be hardware components or software implemented on, and/or executed by, hardware components of the systems. For example, system 100 comprises client devices 102, 104, and 106, local databases 110, 112, and 114, network(s) 108, and server devices 116, 118, and/or 120.

Client devices 102, 104, and 106 may be configured to support determining recorded content to recommend for removal from a storage device. In one example, a client device 102 may be a mobile phone, a client device 104 may be a smart OTA antenna, and a client device 106 may be a broadcast module box (e.g., set-top box). In other example aspects, client device 106 may be a gateway device (e.g., router) that is in communication with sources, such as ISPs, cable networks, internet providers, or satellite networks. Other possible client devices include but are not limited to tablets, personal computers, televisions, etc. In aspects, a client device, such as client devices 102, 104, and 106, may have access to a network from a gateway. In other aspects, client devices 102, 104, and 106, may be equipped to receive data (e.g., instructions from a server) from a gateway. The signals that client devices 102, 104, and 106 may receive may be transmitted from satellite broadcast tower 122. Broadcast tower 122 may also be configured to communicate with network(s) 108, in addition to being able to communicate directly with client devices 102, 104, and 106. In some examples, a client device may be a set-top box that is connected to a display device, such as a television (or a television that may have set-top box circuitry built into the television mainframe).

Client devices 102, 104, and 106 may be configured to run software that allows a user to access the storage optimization system, record media content, and receive recommendations of recorded content to remove from a storage device. Client devices 102, 104, and 106 may access the storage optimization system and the content data through the networks. The data may be stored locally on the client device or run remotely via network(s) 108. For example, a client device may receive a signal from broadcast tower 122 containing content data. The signal may indicate the content data. The client device may receive this content data and subsequently store this data locally in databases 110, 112, and/or 114. In alternative scenarios, the user requested content data may be transmitted from a client device (e.g., client device 102, 104, and/or 106) via network(s) 108 to be stored remotely on server(s) 116, 118, and/or 120. A user may subsequently access the content data from a local database (110, 112, and/or 114) and/or external database (116, 118, and/or 120), depending on where the content data may be stored. The system may be configured to receive content storage data and perform an analysis, to determine when to remove the recorded content, in the background.

In some example aspects, client devices 102, 104, and/or 106 may be equipped to receive signals from an input device. Signals may be received on client devices 102, 104, and/or 106 via Bluetooth, Wi-Fi, infrared, light signals, binary, among other mediums and protocols for transmitting/receiving signals. For example, a user may use a mobile device 102 to check for the content data from a channel from an OTA antenna (e.g., antenna 104). A graphical user interface may display on the mobile device 102 the feature and/or notification data. Specifically, at a particular geolocation, the antenna 104 may receive signals from broadcast tower 122. The antenna 104 may then transmit those signals for analysis via network(s) 108. The results of the analysis may then be displayed on mobile device 102 via network(s) 108. In other examples, the results of the analysis may be displayed on a television device connected to a broadcast module box, such as broadcast module box 106. In some embodiments, server(s) 116, 118, and/or 120 are be configured to support determining recorded content to recommend for removal from a storage device.

In other examples, databases stored on remote servers 116, 118, and 120 may be utilized to assist the system in providing a user access to the storage optimization system. Such databases may contain certain content data, such as user behavior data, historical data, content type data, timing data, or storage device data. Such data may be transmitted via network(s) 108 to client devices 102, 104, and/or 106 to assist in determining recorded content to recommend for removal from a storage device and when to send the recommendation. Because broadcast tower 122 and network(s) 108 are configured to communicate with one another, the systems and methods described herein may be able to identify content data in different sources, such as streaming services, local and cloud storage, cable, satellite, or OTA.

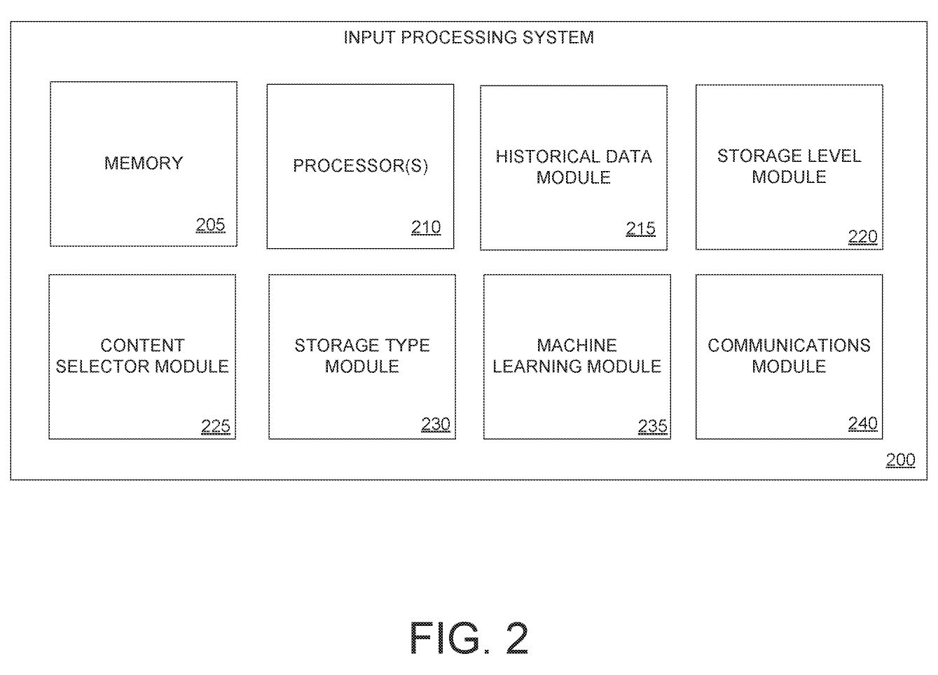

FIG. 2 illustrates an example input processing system for implementing systems and methods for optimizing storage of recorded media content. The input processing system 200 (e.g., one or more data processors) is capable of executing algorithms, software routines, and/or instructions based on processing data provided by a variety of sources related to optimizing storage of recorded media content. The input processing system can be a general-purpose computer or a dedicated, special-purpose computer. According to the embodiments shown in FIG. 2, the disclosed system can include memory 205, one or more processors 210, historical data module 215, storage level module 220, content selector module 225, storage type module 230, machine learning module 235, and communications module 240. Other embodiments of the present technology may include some, all, or none of these modules and components, along with other modules, applications, data, and/or components. Still yet, some embodiments may incorporate two or more of these modules and components into a single module and/or associate a portion of the functionality of one or more of these modules with a different module. The input processing system 200 can be performed by a server or a user device.

Memory 205 can store instructions for running one or more applications or modules on processor(s) 210. For example, memory 205 could be used in one or more embodiments to house all or some of the instructions needed to execute the functionality of historical data module 215, storage level module 220, content selector module 225, storage type module 230, machine learning module 235, and communications module 240. Generally, memory 205 can include any device, mechanism, or populated data structure used for storing information. In accordance with some embodiments of the present disclosures, memory 205 can encompass, but is not limited to, any type of volatile memory, nonvolatile memory, and dynamic memory. For example, memory 205 can be random access memory, memory storage devices, optical memory devices, magnetic media, floppy disks, magnetic tapes, hard drives, SIMMs, SDRAM, RDRAM, DDR, RAM, SODIMMs, EPROMs, EEPROMs, compact discs, DVDs, and/or the like. In accordance with some embodiments, memory 205 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information that can be used as memory 205. In some example aspects, memory 205 may store at least one database containing the content information, historical content information, user behavioral information, user information, and any information associated with the storage optimization system.

Historical data module 215 may be configured to analyzes the consumption history of recorded content by the user. The consumption history can include the type of content, when the content is recorded, when recorded content is consumed, when recorded content is deleted from the storage device, how long between when a type of content is recorded and when the content is consumed, time of year when a type of content is consumed, watching patterns of the user, or any characteristics that identify the type of content consumed by the user and when the content is stored and consumed. In a first example, the consumption history indicates that a user records a Monday night football game on Monday evening and consumes the recorded football game on Wednesday. In a second example, the consumption history indicates that the user regularly records weekly episodes of a TV show but has not consumed any of the recorded TV episodes in several months. In a third example, the consumption history indicates that a particular recorded movie is consumed once a year during the Christmas season. In a fourth example, the consumption history indicates the user deletes a first type of recorded content after consumption but rarely deletes a second type of recorded content after consumption. By analyzing the consumption history, the historical data module 215 can use a user’s behavior of consuming recorded media content to develop a user pattern and predict the likelihood of a user consuming types of recorded content.

Storage level module 220 may be configured to determines the storage amount allocated for the user. The storage allocation can be based on the storage capability of the storage device. In some embodiments, the storage device connects to a server to receive additional storage resources from the server. The storage amount can include the storage resources of the hard drive of the storage device and/or the storage resources provided by the server connected to the storage device. In some embodiments, the storage allocation is based on a subscription of the user. In some embodiments, due to legal requirements associated with storing recorded media content or the storage device(s) being at a multi-dwelling unit (MDU), the storage resources are limited to on-premises servers and the local storage of the hard drive. The storage level module 220 can monitor the available storage resources at the on-premises server and allocate portions of the storage resources to users. In some embodiments, the storage device connects to cloud-based storage resources to increase the storage capability for the user. The storage level module 220 determines the current storage level of the recorded content in the storage device. The current storage level of the storage device can be determined based on the size of the recorded content files in relation to the capacity of the hard drive and other storage resources accessible to the storage device.

Storage level module 220 can predict when the amount of content storage for the user will reach a threshold. The storage level module 220 can predict when the storage will reach a threshold (e.g., 75%, 80%, or any value) based on the consumption history of the user. For example, based on the user routinely recording media content without deleting the content after consumption, the storage level module 220 predicts the user will reach the threshold in a week. The storage level module 220 can calculate the amount of storage the user utilizes in a period (e.g., day, week, month, etc.) to determine when the amount of recorded content will reach the threshold.

Content selector module 225 may be configured to identifies recorded content items to recommend to the user to remove from the storage device. The content selector module 225 can select unwatched recorded content that has been recorded for a time threshold (e.g., a determined number of weeks, such as 5 weeks or any amount of time). The content selector module 225 can select recorded content items based on the type of content. For example, if the user only watches recorded sporting events once but rewatches recorded movies/episodes several times, the content selector module 225 selects recorded sporting events that the user has watched for removal from the storage device. In some embodiments, the recorded content items are selected for removal based on the amount of storage the recorded content occupies. For example, the media content that occupies the most storage is prioritized for removal over other media content.

The content selector module 225 can send recommendation for the user to remove selected content from the storage device. The content selector module 225 can display the recommendation on a display screen connected to the storage device. In some embodiments, the recommendation is sent to a user device associated with the user account. The recommendation can include a prioritized list of recorded content items for the user to delete from the storage device. The content items in the prioritized list can be ordered based on the length of time each content item has been stored on the storage device. In some embodiments, the priority ordering of the recorded content items is based on unwatched content, the type of content, or size of the recorded content file. The recommendation can provide options for the user to delete all the recorded content or select individual recorded content items to delete from the storage device. In some embodiments, the recommendation includes estimate of the storage capacity that the user will regain if they delete specific recorded content.

Storage type module 230 may be configured to determine the type of storage for recorded content to provide to the user based on the activity level of the user. The type of storage can include a conventional hard disk, a solid-state drive (SSD), a hard disk drive (HDD), a USB, or any type of storage. Due to differing costs and levels of performance associated with each type of storage, the storage optimization system can assign different types of storage to each user in a MDU based on the activity level of each user. In a first example, if the user is an active user, such as predicted to record and consume daily content from the storage device, the storage type module 230 assigns SSDs to the active user for a better storage experience. In a second example, if the user is an inactive user, such as predicted to record and consume monthly content from the storage device, the storage type module 230 assigns HDDs to the inactive user as a cost-effective storage option.

Machine learning module 235 may be configured to determine when to recommend a user delete recorded/stored media content from a storage device. The machine learning module 235 may be configured to determine a storage level of storage device and determine when to recommend a user delete recorded media content from the storage device based on at least one machine-learning algorithm trained on at least one dataset reflecting user selected content items to remove from a storage device. The at least one machine-learning algorithms (and models) may be stored locally at databases and/or externally at databases (e.g., cloud databases and/or cloud servers). Client devices (e.g., personal computers, smart phones, tablets, etc.) may be equipped to access these machine learning algorithms and intelligently analyze storage resources and determine when to recommend a user delete recorded media content from a storage device based on at least one machine-learning model that is trained on historical content removal from storage devices. For example, user content recording history may be collected to train a machine-learning model to automatically select and determine when to recommend a user delete recorded media content from the storage device.

As described herein, a machine-learning (ML) model may refer to a predictive or statistical utility or program that may be used to determine a probability distribution over one or more character sequences, classes, objects, result sets or events, and/or to predict a response value from one or more predictors. A model may be based on, or incorporate, one or more rule sets, machine learning, a neural network, or the like. In examples, the ML models may be located on the client device, service device, a network appliance (e.g., a firewall, a router, etc.), or some combination thereof. The ML models may process historical recording data and other data stores (e.g., DVR databases, server storage resources, surveys, etc.) to determine when to recommend a user delete recorded media content from a storage device. Based on an aggregation of data from a content recording database, external/internal portals, user behavioral databases, and other user data stores, at least one ML model may be trained and subsequently deployed to automatically select and determine when to recommend a user delete recorded media content from a storage device. The trained ML model may be deployed to one or more devices. As a specific example, an instance of a trained ML model may be deployed to a server device and to a client device. The ML model deployed to a server device may be configured to be used by the client device when, for example, the client device is connected to the internet. Conversely, the ML model deployed to a client device may be configured to be used by the client device when, for example, the client device is not connected to the internet. In some instances, a client device may not be connected to the internet but still configured to receive satellite signals with connectivity information. In such examples, the ML model may be locally cached by the client device.

Communications module 240 is associated with sending/receiving information (e.g., historical data module 215, storage level module 220, content selector module 225, storage type module 230, and machine learning module 235) with a remote server or with one or more client devices, databases, routers, etc. These communications can employ any suitable type of technology, such as Bluetooth, WiFi, WiMax, cellular, single hop communication, multi-hop communication, Dedicated Short Range Communications (DSRC), or a proprietary communication protocol. In some embodiments, communications module 240 sends historical recording data identified by the historical data module 215, storage information identified by storage level module 220, selected content identified by the content selector module 225, and storage type identified by the storage type module 230.

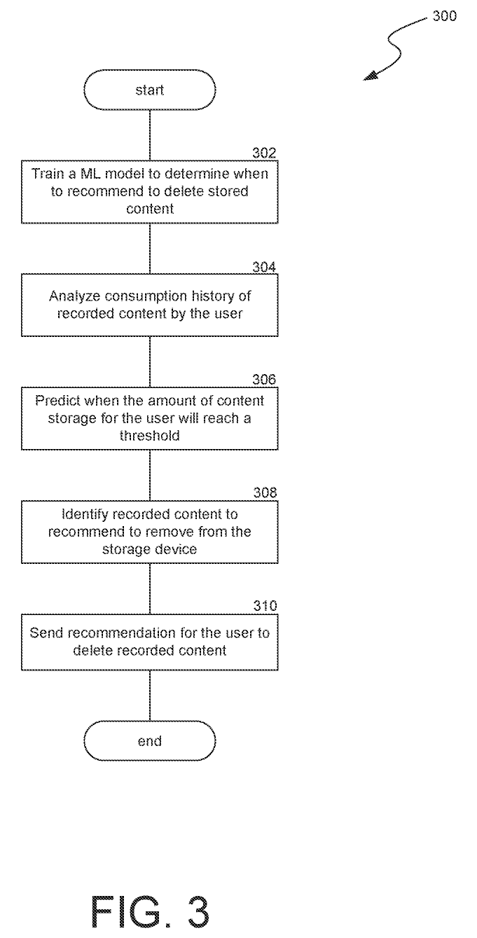

FIG. 3 is a flow diagram illustrating a process 300 used in some implementations for training a machine learning model to determine storage cleanup recommendations, in accordance with one or more embodiments of the present technology. In some implementations, process 300 is triggered by a user activating a storage optimization application, powering on a device, the storage level of the device, recording content to a storage device, or the user downloading an application on a device to access the storage optimization system. In various implementations, some or all of process 300 is performed locally on the user device or performed by cloud-based device(s) that can provide/support the storage optimization system.

At step 302, the storage optimization system trains a machine learning model to determine when to recommend a user delete recorded/stored media content from a storage device (e.g., DVR, NVR, cloud-based storage, etc.). The storage optimization system can utilize various types of machine learning models, algorithms, and techniques to determine when to send the user the recommendation. The machine learning model can include TinyML to reduce power consumption during operations. In some embodiments, the machine learning model is initially trained on a training data set, which is a set of examples used to fit the parameters (e.g., weights of connections between “neurons” in artificial neural networks) of the model. For example, the training data set can include historical consumption data of media content.

In some embodiments, the machine learning model (e.g., a neural network or a naïve Bayes classifier) may be trained on the training data set using a supervised learning method (e.g., gradient descent or stochastic gradient descent). The training data set can include pairs of generated “input vectors” with the associated corresponding “answer vector” (commonly denoted as the target). The current model is run with the training data set and produces a result, which is then compared with the target, for each input vector in the training data set. Based on the result of the comparison and the specific learning algorithm being used, the parameters of the model are adjusted. The model fitting can include both variable selection and parameter estimation. The fitted model can be used to predict the responses for the observations in a second data set called the validation data set. The validation data set can provide an unbiased evaluation of a model fit on the training data set while tuning the model parameters. Validation data sets can be used for regularization by early stopping, e.g., by stopping training when the error on the validation data set increases, as this may be a sign of overfitting to the training data set. In some embodiments, the error of the validation data set error can fluctuate during training, such that ad-hoc rules may be used to decide when overfitting has truly begun. Finally, a test data set can be used to provide an unbiased evaluation of a final model fit on the training data set.

To determine which media content to remove and when to remove the media content from the storage device, historical consumption data can be input into the trained machine learning model(s). Additional data, such as user behavioral data, storage data of other storage devices, user data from other users within the same demographic of the user, or user data from users within the same multi-dwelling unit (MDU), can also be input into the trained machine learning model(s). The trained machine learning model(s) can then calculate whether media content should be removed from the storage device. Based on these calculations, the trained machine learning model(s) can generate and send a recommendation to a user to remove media content from a storage device. For example, the machine learning model determines when to delete content from a storage device based on content the user has watched, watch history, type of content (e.g., e.g., sporting events), when the content is recorded, when the recorded content is consumed, or any parameters that indicate recorded and consumed content of a storage device. In embodiments where multiple trained machine learning models are used, the models can be run sequentially or concurrently to compare outcomes and can be periodically updated using training data sets.

At step 304, the storage optimization system analyzes the consumption history of recorded content by the user. The consumption history can include the type of content, when the content is recorded, when recorded content is consumed, when recorded content is deleted from the storage device, how long between when a type of content is recorded and when the content is consumed, time of year when a type of content is consumed, watching patterns of the user, or any characteristics that identify the type of content consumed by the user and when the content is stored and consumed. In a first example, the consumption history indicates that a user records a Monday night football game on Monday evening and consumes the recorded football game on Wednesday. In a second example, the consumption history indicates that the user regularly records weekly episodes of a TV show but has not consumed any of the recorded TV episodes in several months. In a third example, the consumption history indicates that a particular recorded movie is consumed once a year during the Christmas season. In a fourth example, the consumption history indicates the user deletes a first type of recorded content after consumption but rarely deletes a second type of recorded content after consumption. By analyzing the consumption history, the storage optimization system can use a user’s behavior of consuming recorded media content to develop a user pattern and predict the likelihood of a user consuming types of recorded content.

At step 306, the storage optimization system predicts when the amount of content storage for the user will reach a threshold. The storage optimization system can predict when the storage will reach a threshold (e.g., 75%, 80%, or any value) based on the consumption history of the user. For example, based on the user routinely recording media content without deleting the content after consumption, the storage optimization system predicts the user will reach the threshold in a week. The storage optimization system can calculate the amount of storage the user utilizes in a period (e.g., day, week, month, etc.) to determine when the amount of recorded content will reach the threshold.

At step 308, the storage optimization system identifies recorded content items to recommend to the user to remove from the storage device. The storage optimization system can select unwatched recorded content that has been recorded for a time threshold (e.g., a determined number of weeks, such as 5 weeks or any amount of time). The storage optimization system can select recorded content items based on the type of content. For example, if the user only watches recorded sporting events once but rewatches recorded movies/episodes several times, the system selects recorded sporting events that the user has watched for removal from the storage device. In some embodiments, the recorded content items are selected for removal based on the amount of storage the recorded content occupies. For example, the media content that occupies the most storage is prioritized for removal over other media content. The storage optimization system can select recorded content for removal based on the content type, such as a genre specific recommendation. For example, the storage optimization system selects comedy content that is unwatched for a first time threshold (e.g., 5 weeks), while selecting documentary content that is unwatched for a second time threshold (e.g., 8 weeks). The storage optimization system can select recorded content for removal based on the parameters, such as metadata of recorded content. The parameters can include actor details, director details, series title etc. For example, if a user has a watch history of regularly watching movies starring a particular actor, the storage optimization system delays recommending removal of movies starring the particular actor as the probability of user deleting that movie will be less. The storage optimization system can track a user’s cleaning/deleting pattern to determine if user is more likely to cleanup their DVR in the morning or evening, weekends or weekdays, and determine when to send the user the removal recommendation.

At step 310, the storage optimization system sends a recommendation for the user to remove selected content from the storage device. The storage optimization system can display the recommendation on a display screen connected to the storage device. In some embodiments, the recommendation is sent to a user device associated with the user account. The recommendation can include a prioritized list of recorded content items for the user to delete from the storage device. The content items in the prioritized list can be ordered based on the length of time each content item has been stored on the storage device. In some embodiments, the priority ordering of the recorded content items is based on unwatched content, the type of content, or size of the recorded content file. The recommendation can provide options for the user to delete all the recorded content or select individual recorded content items to delete from the storage device. In some embodiments, the recommendation includes estimate of the storage capacity that the user will regain if they delete specific recorded content. In some embodiments, the storage optimization system perform process 300 for an MDU. For example, the storage optimization system analyzes the storage levels associated with the MDU and recommends users remove content when the storage levels reach a threshold.

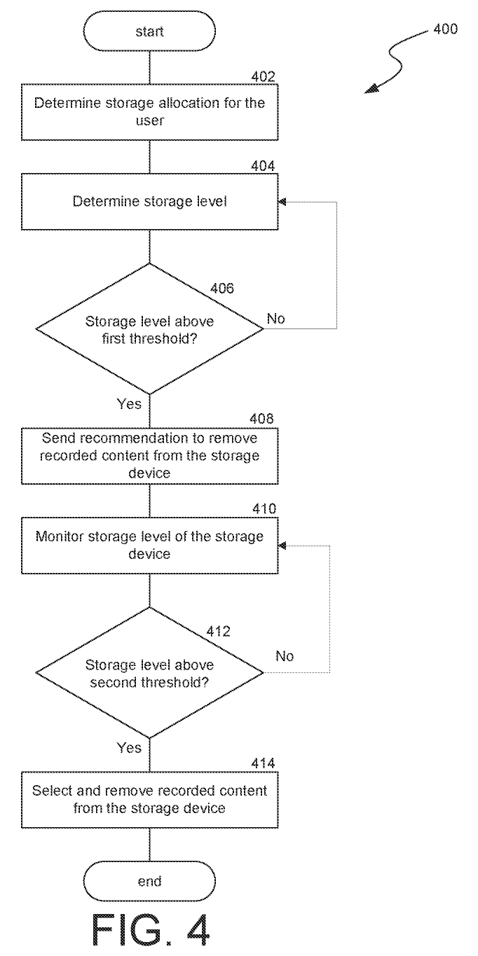

FIG. 4 is a flow diagram illustrating a process 400 used in some implementations for removing stored media content from a storage device, in accordance with one or more embodiments of the present technology. In some implementations, process 400 is triggered by a user activating a storage optimization application, powering on a device, the storage level of the device, recording content to a storage device, or the user downloading an application on a device to access the storage optimization system. In various implementations, some or all of process 400 is performed locally on the user device or performed by cloud-based device(s) that can provide/support the storage optimization system.

At step 402, the storage optimization system determines the storage amount allocated for the user at an MDU. The storage allocation can be based on the storage capability of the storage device. The storage capability can include size of the hard drive and/or the storage available in the hard drive for storing recordings. In some embodiments, the storage device connects to a server (e.g., an on-premises server at the MDU) to receive additional storage resources from the server. The storage amount can include the storage resources of the hard drive of the storage device and/or the storage resources provided by the server connected to the storage device. In some embodiments, the storage allocation is based on a subscription of the user. In some embodiments, due to legal requirements associated with storing recorded media content or the storage optimization system being associated with a MDU, the storage resources are limited to on-premises servers and the local storage of the hard drive. The storage optimization system can monitor the available storage resources at the on-premises server and allocate portions of the storage resources to users. In some embodiments, the storage device connects to cloud-based storage resources to increase the storage capability for the user.

At step 404, the storage optimization system determines the current storage level of the recorded content in the storage device. The current storage level of the storage device can be determined based on the size of the recorded content files in relation to the capacity of the hard drive and other storage resources accessible to the storage device.

At step 406, the storage optimization system determines whether the current storage level is above a first threshold of the total storage amount allocated for the user. For example, the storage optimization system determines whether the current storage level is above 70% of the total storage amount. If the current storage level is not above the first threshold, the storage optimization system can continue to determine the current storage level of the user (at step 404).

If the current storage level is above the first threshold of the total storage amount allocated for the user, at step 408, the storage optimization system sends a recommendation for the user to remove recorded content from the storage device. The storage optimization system can recommend the user remove unwatched recorded content items that has been recorded for a time threshold (e.g., a determined number of weeks, such as 5 weeks or any amount of time). The storage optimization system can recommend removal of recorded content items based on the type of content. For example, if the user only watches recorded movies once but rewatches recorded sporting events several times, the system recommends recorded movies that the user has watched for removal from the storage device. In some embodiments, the recorded content is recommended for removal based on the amount of storage the recorded content occupies. For example, the media content that occupies storage above a threshold amount (e.g., 10 Gigabytes) is prioritized for removal over other media content.

After sending the recommendation, at step 410, the storage optimization system monitors the storage device to determines whether the user has removed any recorded content items from the storage device. At step 412, the storage optimization system determines whether the current storage level is above a second threshold of the total storage amount allocated for the user. For example, the storage optimization system determines whether the current storage level is above 90% of the total storage amount. If the current storage level is not above the second threshold of the total storage amount allocated for the user, the storage optimization system can continue to monitor the current storage level (at step 410).

If the current storage level is above the second threshold of the total storage amount allocated for the user, at step 414, the storage optimization system selects and removes recorded content items from the storage device. The storage optimization system can select recorded content items for removal using techniques describes at step 306 of FIG. 3. In a first example, the storage optimization system removes the recorded content items recommended in the recommendation sent to the user at step 408. In a second example, the storage optimization system removes a volume of recorded content to lower the storage level below the first or second threshold level. In a third example, the storage optimization system removes recorded content items that has been stored on the storage device for more than a time threshold.

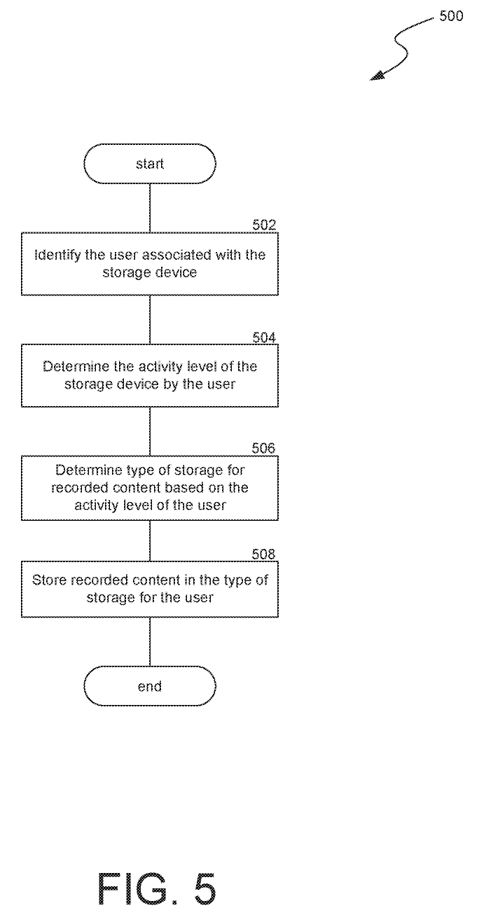

FIG. 5 is a flow diagram illustrating a process 500 used in some implementations for determining the type of storage for a user, in accordance with one or more embodiments of the present technology. In some implementations, process 500 is triggered by a user activating a storage optimization application, powering on a device, the storage level of the device, recording content to a storage device, or the user downloading an application on a device to access the storage optimization system. In various implementations, some or all of process 500 is performed locally on the user device or performed by cloud-based device(s) that can provide/support the storage optimization system.

At step 502, the storage optimization system identifies the user associated with the storage device of an MDU based on user credentials, user location, storage device identifier information, or any user account information. The storage optimization system can identify the user to differentiate the user from other users in an MDU. In some embodiments, users associated with an MDU share storage resources provided by a server connected to the storage devices at the MDU. For example, a server provides additional storage to each user’s DVR to increase the storage capability for each user at the MDU.

At step 504, the storage optimization system determines the activity level of the storage device by the user. The activity level can include the frequency that the user records content to the storage device. For example, a user who records content daily has a high activity level, a user who records content weekly has a medium activity level, and a user who records content monthly has a low activity level. The activity level can include the amount of recorded content consumed by user, how often the user deletes recorded content, and/or how much content is recorded and deleted within a time threshold.

At step 506, the storage optimization system determines the type of storage for recorded content to provide to the user based on the activity level of the user. The type of storage can include a conventional hard disk, a solid-state drive (SSD), a hard disk drive (HDD), a USB, or any type of storage. Due to differing costs and levels of performance associated with each type of storage, the storage optimization system can assign different types of storage to each user in a MDU based on the activity level of each user. In a first example, if the user is an active user, such as predicted to record and consume daily content from the storage device, the storage optimization system assigns SSDs to the active user for a better storage experience. In a second example, if the user is an inactive user, such as predicted to record and consume monthly content from the storage device, the storage optimization system assigns HDDs to the inactive user as a cost-effective storage option. The storage optimization system can determine the type of storage for recorded content to provide to the user based on a subscription or premium paid by the user for storage. For example, for a premium paid active user, the storage optimization system assigns SSD or nonvolatile memory express (NVME) storage to the user for better optimized user experience. At step 508, the storage optimization system stores recorded content in the type of storage assigned for the user.

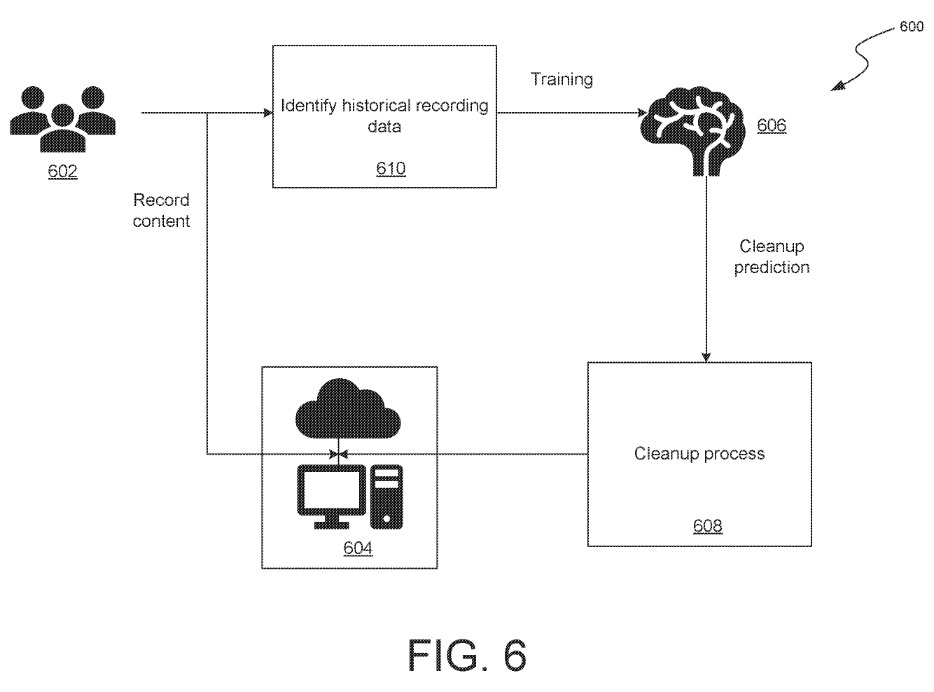

FIG. 6 is a diagram illustrating an example system 600 for optimizing storage of recorded media content, in accordance with one or more embodiments of the present technology. System 600 can identify when users 602 record media content to storage device 604 (e.g., a DVR, server, and/or cloud-based device). The system 600 maintains a history of the recordings and identifies the type of content, time of recording, and time of consumption by the user. For example, the historical data indicates how long after recording content that the user watches the content, does the user re-watch any type of content, or is the recorded content watched by any other user in the MDU.

System 600 trains machine learning model(s) 606 with the historical recording data 610 to determine when to recommend a user delete recorded media content from storage device 604. The machine learning model 606 can generate clean-up prediction data to predict when the user will record content, consume content, and whether the user will delete the content after consumption.

Based on the cleanup prediction data, system 600 performs a cleanup process 608 by deleting some or all the recorded content. For example, system 600 performs any of the steps of FIGS. 3-5 to identify, select, and remove recorded content from the storage device 604. Once content is deleted from the storage device 604, system 600 continues to monitor the storage level of the storage device 604.

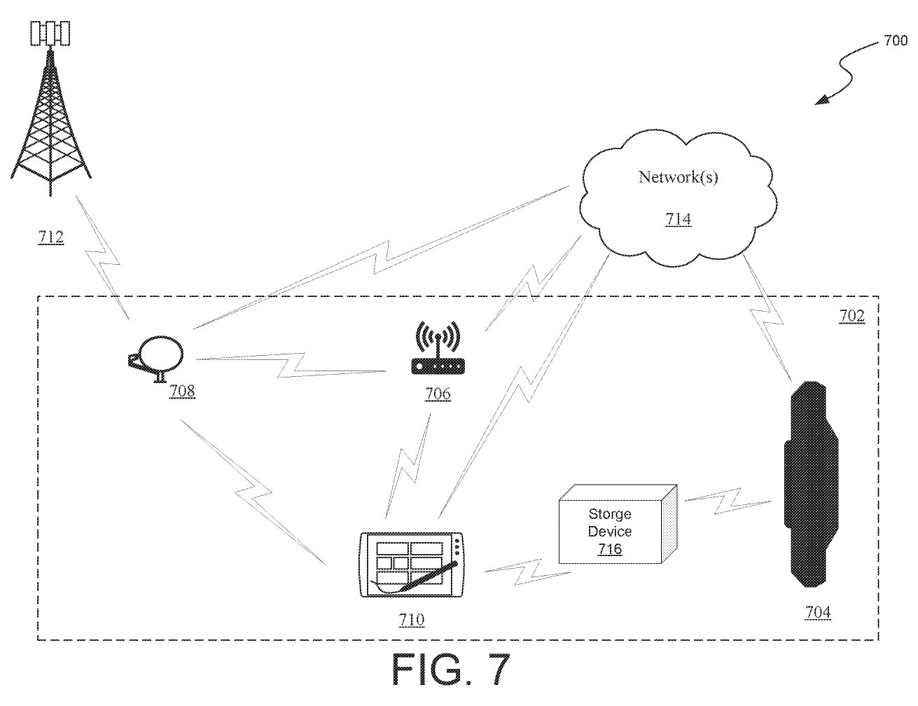

FIG. 7 illustrates an example environment of operation of the disclosed technology. In the example environment 700 illustrated in FIG. 7, area 702 may represent a house, a commercial building, an apartment, a condo, or any other type of suitable dwelling. Inside area 702 is at least one television 704, an OTA box 706 (e.g., broadcast module box, such as a set-top box)), an OTA antenna 708, and a mobile device 710. Each of these devices may be configured to communicate with network(s) 714. OTA box 706 may be configured as a central gateway communicable with various multimedia content providers and devices, among other servers and databases housing multimedia content available for retrieval and display on user devices. OTA box 706, mobile device 710, and television 704 may participate in the storage optimization system and communicate with storage device 716 (e.g., a DVR device). Network(s) 714 may be a WiFi network and/or a cellular network. The OTA antenna 708 may also be configured to receive local broadcast signals from local broadcast tower 712 or satellite broadcast tower.

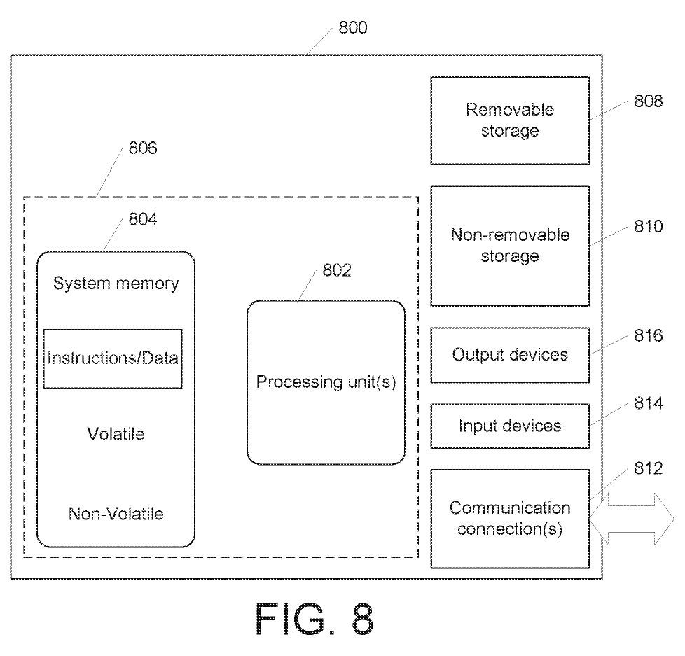

FIG. 8 illustrates one example of a suitable operating environment in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 800 typically includes at least one processing unit 802 and memory 804. Depending on the exact configuration and type of computing device, memory 804 (storing, among other things, information related to detected devices, compression artifacts, association information, personal gateway settings, and instruction to perform the methods disclosed herein) may be volatile (such as RAM), non-volatile (such as ROM, flash memory, etc.), or some combination of the two. This most basic configuration is illustrated in FIG. 8 by dashed line 806. Further, environment 800 may also include storage devices (removable 808 and/or non-removable 810) including, but not limited to, magnetic or optical disks or tape. Similarly, environment 800 may also have input device(s) 814 such as keyboard, mouse, pen, voice input, etc., and/or output device(s) 816 such as a display, speakers, printer, etc. Also included in the environment may be one or more communication connections, 812, such as Bluetooth, WiFi, WiMax, LAN, WAN, point to point, etc.

Operating environment 800 typically includes at least some form of computer readable media. Computer readable media can be any available media that can be accessed by processing unit 802 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM EEPROM, flash memory or other memory technology, CD-ROM, digital versatile disks (DVD) or other optical storage, magnetic cassettes, magnetic tape, magnetic disk storage, or other magnetic storage devices, or any other tangible medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulate data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The operating environment 800 may be a single computer (e.g., mobile computer) operating in a networked environment using logical connections to one or more remote computers. The remote computer may be a personal computer, a server, a router, a network PC, a peer device, an OTA antenna, a set-top box, or other common network node, and typically includes many or all of the elements described above as well as others not so mentioned. The logical connections may include any method supported by available communications media. Such networking environments are commonplace in offices, enterprise-wide computer networks, intranets, and the Internet.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of the claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and the alternate aspects falling within the spirit of the broader aspects of the general inventive concept embodied in this application that do not depart from the broader scope of the claimed disclosure.

From the foregoing, it will be appreciated that specific embodiments of the invention have been described herein for purposes of illustration, but that various modifications may be made without deviating from the scope of the invention. Accordingly, the invention is not limited except as by the appended claims. Unless the context clearly requires otherwise, throughout the description and the claims, the words "comprise," "comprising," and the like are to be construed in an inclusive sense, as opposed to an exclusive or exhaustive sense; that is to say, in the sense of "including, but not limited to." As used herein, the terms "connected," "coupled," or any variant thereof means any connection or coupling, either direct or indirect, between two or more elements; the coupling or connection between the elements can be physical, logical, or a combination thereof. Additionally, the words "herein," "above," "below," and words of similar import, when used in this application, refer to this application as a whole and not to any particular portions of this application. Where the context permits, words in the above Detailed Description using the singular or plural number may also include the plural or singular number respectively.

Several implementations of the disclosed technology are described above in reference to the figures. The computing devices on which the described technology may be implemented can include one or more central processing units, memory, user devices (e.g., keyboards and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., "non-transitory" media) and computer-readable transmission media.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range.

As used herein, the word "or" refers to any possible permutation of a set of items. For example, the phrase "A, B, or C" refers to at least one of A, B, C, or any combination thereof, such as any of: A; B; C; A and B; A and C; B and C; A, B, and C; or multiple of any item, such as A and A; B, B, and C; A, A, B, C, and C; etc.

The above Detailed Description of examples of the technology is not intended to be exhaustive or to limit the technology to the precise form disclosed above. While specific examples for the technology are described above for illustrative purposes, various equivalent modifications are possible within the scope of the technology. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

What is claimed is:

1. A method for optimizing storage of media content on storage resources at a multi-dwelling unit (MDU), the method comprising:
identifying a recording pattern of a user recording media content items to the storage resources at the MDU;
determining an amount of the storage resources available to the user;
determining a predicted time that a recorded content amount to the storage resources will reach a first threshold storage level based on the recording pattern and the amount of the storage resources;
selecting at least one media content item to delete from the storage resources at the MDU; and
sending a recommendation to the user to delete the at least one media content item from the storage resources.

2. The method of claim 1, further comprising:
selecting the at least one media content item to delete, by:
identifying recorded media content items that the user has consumed;
generating a priority list of the recorded media content items that the user has consumed; and
selecting the at least one media content item from the priority list based on a length of time the at least one media content item has been stored on the storage resources.

3. The method of claim 1, further comprising:
determining the storage resources include a storage device connected to an on-premises server at the MDU;
determining a storage capacity at the on-premises server allocated for the user; and
determining the amount of the storage resources available to the user based on storage resources locally available on the storage device and based further upon the on-premises server storage allocation for the user.

4. The method of claim 1, further comprising:
in response to the recorded content amount reaching a second threshold;
selecting one or more recorded media content items for removal from the storage resources; and
deleting the one or more recorded media content items from the storage resources.

5. The method of claim 1, the method further comprising:
determining an activity level of recording and consuming media content by the user; and
determining a type of storage to store recorded media content for the user based on the activity level of the user.

6. The method of claim 1, wherein the at least one media content item is identified by at least one machine-learning algorithm, wherein the at least one machine-learning algorithm is trained based on at least one dataset associated with previously identified media content items.

7. The method of claim 1, wherein the storage resources include a storage device connected to at least one cloud-based storage device, wherein the amount of the storage resources includes storage resources available at the at least one cloud-based storage device.

8. A system comprising:
one or more processors; and
one or more memories storing instructions that, when executed by the one or more processors, cause the system to perform a process for optimizing storage of media content on storage resources at a multi-dwelling unit (MDU), the process comprising:
identifying a recording pattern of a user recording media content items to the storage resources at the MDU;
determining an amount of the storage resources available to the user;
determining a predicted time that a recorded content amount to the storage resources will reach a first threshold storage level based on the recording pattern and the amount of the storage resources;
selecting at least one media content item to delete from the storage resources at the MDU; and
sending a recommendation to the user to delete the at least one media content item from the storage resources.

9. The system according to claim 8, wherein the process further comprises:
selecting the at least one media content item to delete, by:
identifying recorded media content items that the user has consumed;
generating a priority list of the recorded media content items that the user has consumed; and
selecting the at least one media content item from the priority list based on a length of time the at least one media content item has been stored on the storage resources.

10. The system according to claim 8, wherein the process further comprises:
determining the storage resources include a storage device connected to an on-premises server at the MDU;
determining a storage capacity at the on-premises server allocated for the user; and
determining the amount of the storage resources available to the user based on storage resources locally available on the storage device and based further upon the on-premises server storage allocation for the user.

11. The system according to claim 8, wherein the process further comprises:
in response to the recorded content amount reaching a second threshold;
selecting one or more recorded media content items for removal from the storage resources; and
deleting the one or more recorded media content items from the storage resources.

12. The system according to claim 8, wherein the process further comprises:
determining an activity level of recording and consuming media content by the user; and
determining a type of storage to store recorded media content for the user based on the activity level of the user.

13. The system according to claim 8, wherein the at least one media content item is identified by at least one machine-learning algorithm, wherein the at least one machine-learning algorithm is trained based on at least one dataset associated with previously identified media content items.

14. The system according to claim 8, wherein the storage resources include a storage device connected to at least one cloud-based storage device, wherein the amount of the storage resources includes storage resources available at the at least one cloud-based storage device.

15. A non-transitory computer-readable medium storing instructions that, when executed by a computing system, cause the computing system to perform operations for optimizing storage of media content on storage resources at a multi-dwelling unit (MDU), the operations comprising:
identifying a recording pattern of a user recording media content items to the storage resources at the MDU;
determining an amount of the storage resources available to the user;
determining a predicted time that a recorded content amount to the storage resources will reach a first threshold storage level based on the recording pattern and the amount of the storage resources;
selecting at least one media content item to delete from the storage resources at the MDU; and
sending a recommendation to the user to delete the at least one media content item from the storage resources.

16. The non-transitory computer-readable medium of claim 15, wherein the operations further comprise:
selecting the at least one media content item to delete, by:
identifying recorded media content items that the user has consumed;
generating a priority list of the recorded media content items that the user has consumed; and
selecting the at least one media content item from the priority list based on a length of time the at least one media content item has been stored on the storage resources.

17. The non-transitory computer-readable medium of claim 15, wherein the operations further comprise:
determining the storage resources include a storage device connected to an on-premises server at the MDU;
determining a storage capacity at the on-premises server allocated for the user; and
determining the amount of the storage resources available to the user based on storage resources locally available on the storage device and based further upon the on-premises server storage allocation for the user.

18. The non-transitory computer-readable medium of claim 15, wherein the operations further comprise:
in response to the recorded content amount reaching a second threshold;
selecting one or more recorded media content items for removal from the storage resources; and
deleting the one or more recorded media content items from the storage resources.

19. The non-transitory computer-readable medium of claim 15, wherein the operations further comprise:
determining an activity level of recording and consuming media content by the user; and
determining a type of storage to store recorded media content for the user based on the activity level of the user.

20. The non-transitory computer-readable medium of claim 15, wherein the at least one media content item is identified by at least one machine-learning algorithm, wherein the at least one machine-learning algorithm is trained based on at least one dataset associated with previously identified media content items.
